(19) United States
(12) Patent Application Publication
(10) Pub. No.: US 2025/0112684 A1
(43) Pub. Date: Apr. 3, 2025

(54) SYSTEMS AND METHODS FOR USER EQUIPMENT BEAM TRACKING BASED ON SENSING INFORMATION

(71) Applicant: Huawei Technologies Co., Ltd., Shenzhen (CN)

(72) Inventors: Mostafa Medra, Kanata (CA); Mohammadhadi Baligh, Ottawa (CA)

(21) Appl. No.: 18/957,219

(22) Filed: Nov. 22, 2024

Related U.S. Application Data
(63) Continuation of application No. PCT/CN2022/094702, filed on May 24, 2022.

(51) Int. Cl. H04B 7/08; H04B 7/06

(52) U.S. Cl. CPC H04B 7/088; H04B 7/0628

(57) ABSTRACT

Methods and devices are provided that enable user equipment (UE) beam tracking. The method includes: transmitting user equipment (UE) beam tracking capability information, receiving beam tracking update configuration information, updating a UE beam based on the UE beam tracking capability information and the beam tracking update configuration information.

### CROSS-REFERENCE TO RELATED APPLICATIONS

The application is a continuation of International Application No. PCT/CN2022/094702, filed on May 24, 2022, the disclosure of which is hereby incorporated by reference in its entirety.

### TECHNICAL FIELD

The present disclosure relates generally to wireless communications, and in particular embodiments, systems and method for user equipment (UE) beam tracking based on sensing information in communication systems.

### BACKGROUND

In some wireless communication systems, user equipments (UEs) wirelessly communicate with a base station (for example, NodeB, evolved NodeB or gNB) to send data to the base station and/or receive data from the base station. A wireless communication from a UE to a base station is referred to as an uplink (UL) communication. A wireless communication from a base station to a UE is referred to as a downlink (DL) communication. A wireless communication from a first UE to a second UE is referred to as a sidelink (SL) communication or device-to-device (D2D) communication.

Resources are required to perform uplink, downlink and sidelink communications. For example, a base station may wirelessly transmit data, such as a transport block (TB), to a UE in a downlink transmission at a particular frequency and over a particular duration of time. The frequency and time duration used are examples of resources.

When the UE and the base station are equipped with multiple antennas, these two devices may perform analog beamforming that may provide additional gains to the communication link. Such gains may be crucial for operation at higher frequencies to combat larger channel path loss at those frequencies. Analog beamforming is performed by adjusting the phases of each antenna in an antenna array that is connected to a single radio frequency (RF) chain. Such phase adjustment results in the signal being beam shaped in a certain direction. The set of phases for the respective antennas that points toward a certain angle or direction is known as an analog beamformer. A set of analog beamformers may be referred to as a codebook and can be stored for use to configure beams for a variety of different directions. Using a discrete Fourier transform (DFT) matrix as a codebook is common in analog beamforming, where each column of the matrix is a beamformer that points in a certain direction and the number of rows in the matrix is equal to the number of antennas in the array.

Some beam management procedures rely on reference signal received power (RSRP) of the beam to decide which beam to use for communication. When the UE beam is misaligned, the RSRP measurements may result in wrong decisions regarding beam selection deteriorating the system performance. For example, a base station may instruct the UE to switch beams based on RSRP measurements from the UE, but the operating beam is actually better than the new beam due to UE beam misalignment. In another scenario, a UE may declare beam failure when RSRP drops below a threshold value, but the actual problem may be due to large beam misalignment at the UE side. Avoiding such situations by UE beam sweeping might cause a large delay and wasting time and frequency resources.

### SUMMARY

Methods and devices are disclosed that enable UE beam tracking so that the UE may update the UE beam potentially providing improved beam pair RSRP and lower overhead. Also, the UE may track other beams that may be used for other beam management methods.

According to aspects of the disclosure there is provided a method involving: transmitting, by a user equipment (UE), UE beam tracking capability information; receiving, by the UE, beam tracking update configuration information; and updating, by the UE, a UE beam based on the UE beam tracking capability information and the beam tracking update configuration information; wherein the updating the UE beam is performed: periodically; or aperiodically; or as a result of a triggering signal.

In some embodiments, the beam tracking update configuration information provides information for tracking one or more of: a UE beam for a serving beam; or an alternative UE beam for UE beam management processes.

In some embodiments, the UE beam is one or more of: a UE beam that is used for the serving beam; a UE beam that is used for beam switching; a UE beam that is used for handover; or a UE beam that is used for beam failure recovery.

In some embodiments, the UE beam tracking capability information comprises one or more of: an indication of a capability of the UE to compensate for UE orientation changes; an indication as to whether the UE can use an equation provided in beam tracking update configuration information to update beam information; an indication as to whether the UE includes at least one of a gyroscope or compass; an indication of a number of antenna panels at the UE; and an indication as to whether the UE is capable of beamform one or more beams.

In some embodiments, the beam tracking update configuration information comprises one or more of: beam angle information; equation information enabling at least one of a time dependent update or a location dependent update; geometry information pertaining to a reflector between the UE and a serving base station; and reflector location information.

In some embodiments, the beam angle information is one of an absolute angle, a relative angle or an angular range.

In some embodiments, the update configuration information includes an indication for the UE to beam sweep over the angular range.

In some embodiments, the equation information is received in at least one of radio resource control (RRC) signaling or media access control-control element (MAC-CE).

In some embodiments, the method further involves coordinating UE orientation with directionality information with respect to a base station.

In some embodiments, the beam tracking update configuration information is based on at least one of: movement of the UE; movement of a base station; or movement of signal reflector between the serving base station and the UE.

In some embodiments, the method further involves receiving or transmitting, by the UE, data over the updated UE beam.

According to aspects of the disclosure there is provided an apparatus including a processor and a computer-readable medium. The computer-readable medium has stored thereon computer executable instructions that when executed by the processor cause the apparatus to perform the method described above or detailed below.

According to aspects of the disclosure there is provided a method involving: receiving, by a base station, UE beam tracking capability information; and transmitting, by the base station, beam tracking update configuration information; wherein the UE beam tracking capability information and the beam tracking update configuration information are used to update a UE receive beam periodically or aperiodically or as a result of a triggering signal.

In some embodiments, the beam tracking update configuration information provides information for tracking one or more of: a UE beam for a serving beam; or an alternative UE beam for UE beam management processes.

In some embodiments, the alternative UE receive beam or beam pair is one of: a UE beam that is used for the serving beam; a UE beam that is used for beam switching; a UE beam that is used for handover; or a UE beam that is used for beam failure recovery.

In some embodiments, the UE beam tracking capability information comprises one or more of: an indication of a capability of the UE to compensate for UE orientation changes; an indication as to whether the UE can use an equation provided in beam tracking update configuration information to update beam information; an indication as to whether the UE includes at least one of a gyroscope or compass; an indication of a number of antenna panels at the UE; and an indication as to whether the UE is capable of beamform one or more beams.

In some embodiments, the beam tracking update configuration information comprises one or more of: beam angle information; equation information enabling at least one of a time dependent update or a location dependent update; geometry information pertaining to a reflector between the UE and the base station; and reflector location information.

In some embodiments, the beam angle information is one of an absolute angle, a relative angle or an angular range.

In some embodiments, the update configuration information includes an indication for the UE to beam sweep over the angular range.

In some embodiments, equation information is transmitted in at least one of RRC signaling or MAC-CE.

In some embodiments, the method further involves coordinating UE orientation with directionality information with respect to a base station.

In some embodiments, the beam tracking update configuration information is based on at least one of: movement of the UE; movement of a base station; or movement of a signal reflector between the base station and the UE.

In some embodiments, the method further involves receiving or transmitting, by the base station, data over the updated UE beam.

According to aspects of the disclosure there is provided an apparatus including a processor and a computer-readable medium. The computer-readable medium has stored thereon computer executable instructions that when executed by the processor cause the apparatus to perform the method described above or detailed below.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1A is a schematic diagram of a communication system in which embodiments of the disclosure may occur.

FIG. 1B is another schematic diagram of a communication system in which embodiments of the disclosure may occur.

FIG. 2 is a block diagram illustrating units or modules in a device in which embodiments of the disclosure may occur.

FIG. 3 is a block diagram illustrating units or modules in a device in which embodiments of the disclosure may occur.

FIGS. 4A and 4B are schematic diagrams of a base station in communication with a user equipment (UE) with a direct line-of-sight (LOS) link and a non-line-of-sight (NLOS) link via a reflector according to aspects of the disclosure.

FIG. 5 is an example of a signaling flow diagram for signaling between a base station and a UE utilizing UE beam tracking according to an aspect of the present disclosure.

FIG. 6 is another example of a signaling flow diagram for signaling between a base station and a UE utilizing UE beam tracking according to an aspect of the present disclosure.

FIG. 7 is a further example of a signaling flow diagram for signaling between a base station and a UE utilizing UE beam tracking according to an aspect of the present disclosure.

### DETAILED DESCRIPTION OF ILLUSTRATIVE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

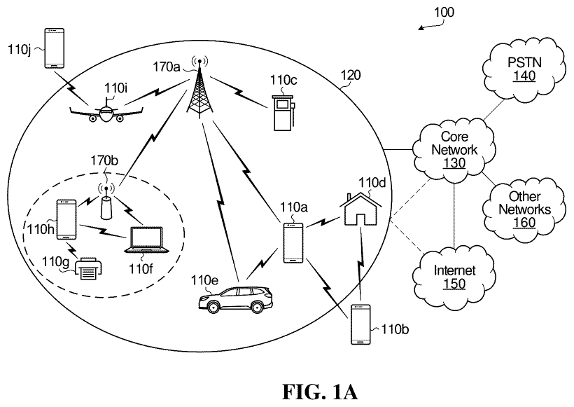

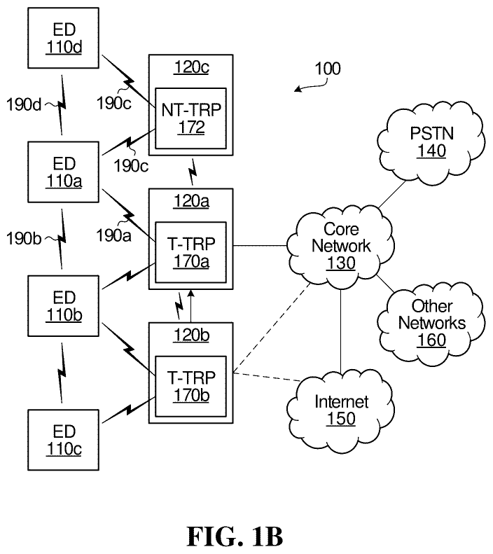

FIGS. 1A, 1B, and 2 following below provide context for the network and device that may be in the network and that may implement aspects of the present disclosure.

Referring to FIG. 1A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

FIG. 1B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 1B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 1B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 1B, any reasonable number of these components or elements may be included in the communication system 100.

The EDs 110a-110d are configured to operate, communicate, or both, in the communication system 100. For example, the EDs 110a-110d are configured to transmit, receive, or both, via wireless or wired communication channels. Each ED 110a-110d represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 1B, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 1B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110c over one or more air interfaces 190a, 190c using wireless communication links e.g. radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b, 172 may implement Universal Mobile Telecommunication System (UMTS) Terrestrial Radio Access (UTRA) to establish an air interface 190a, 190c using wideband CDMA (WCDMA). In doing so, the base station 170a-170b.172 may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b,172 may establish an air interface 190a,190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110d communicate with one another over one or more sidelink (SL) air interfaces 190b, 190d using wireless communication links e.g. radio frequency (RF), microwave, infrared (IR), etc. The SL air interfaces 190b, 190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b, 190d. In some embodiments, the SL air interfaces 180 may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIG. 2 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 2, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1A or 1B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 2. FIG. 2 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

While not shown in FIG. 2, a RIS may be located between the ED 110 and the NT-TRP 172 or between the ED 110 and the T-TRP 170, in a similar manner as RIS 182 is shown between the EDs 110 and base station 170b in FIG. 1B. A RIS may be located between the NT-TRP 172 and the T-TRP 170 to aid in communication between the two TRPs.

Additional details regarding the EDs 110, T-TRP 170, and NT-TRP 172 are known to those of skill in the art. As such, these details are omitted here.

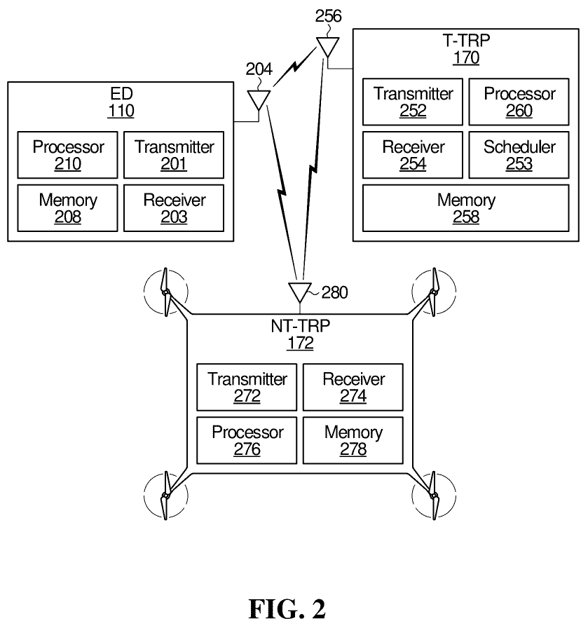

One or more steps of the embodiment methods provided herein may be performed by corresponding units or modules, according to FIG. 3. FIG. 3 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent MCS, intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. New protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework

As discussed above, UE beam misalignment may cause a decrease in reference signal received power (RSRP) of a beam pair, which includes a base station beam and a UE beam for use in uplink or downlink communication. For side link (SL) communication, a beam pair may include beams for two UE involved in the SL communication. Such a decrease in RSRP may result in a reduction in a communication rate of communications over the beam pair. Alignment of the UE beam by performing beam sweeping by the base station or UE may utilize large overhead thereby wasting time and frequency resources. Methods presented in this disclosure may enable UE beam tracking in an efficient manner providing improved beam alignment with lower overhead. In some embodiments, the methods may benefit from sensing techniques to tailor beam tracking to different UE requirements and/or capabilities.

Embodiments of the invention provide methods that enable UE beam tracking in an efficient way. The methods provide better beam alignment that may provide higher beam RSRP and lower overhead. The methods enable tracking of a serving beam and/or other beams that may be used in various beam management methods.

After the UE and the base station align their respective beams and form a beam pair, the UE beam may lose alignment with the base station due to various reasons. For example, the UE may lose alignment due to UE movement or base station movement (if the base station is capable of moving; e.g., drone) or when the beam is reflected from a reflector that can move; e.g., non-line of sight (NLOS) reflected from a truck. Another reason for UE beam misalignment may be the UE changing orientation.

In some embodiments, a UE beam tracking method includes the base station providing the UE with configuration information that enables the UE to track a UE beam or more than one UE beam. In some embodiments, the UE is capable of compensating for orientation changes that occur at the UE so that the UE may apply the UE beam tracking in addition to orientation changes that may occur at the UE. In some embodiments, the UE is capable of updating the UE beam in terms of local coordinates at the UE when instructed to update the UE beam by the base station. For example, if the base station configures the UE to increase an azimuth angle of the UE beam by +10 degrees, the UE may be oriented relative to the base station coordinates and may have to adjust the UE beam angle in a way that is translated to +10 degrees. The UE may use sensors that are part of the UE, such as a gyroscope or compass, in addition to configuration information from the base station and measurements pertaining to one or more beams to enable relating the UE orientation to the base station or network coordinates. In some embodiments, UEs may require different ways to establish an orientation translation. For example, a UE that is a car may place more focus on the azimuth orientation, which may be obtained based on where the car is heading, rather than on an elevation orientation that may vary slightly according to topography of the road the car is travelling on. In another example, a UE that is a laptop, may relate information about the laptop orientation based on the screen position. In a third example, a UE that is a train may know exactly the train orientation with a high amount of precision. Accordingly, different UEs may relate their orientation in different ways to the base station, according to the particular UE's nature, sensing information availability and the UE environment.

Once the UE has related the UE orientation to a coordinate scheme corresponding to the base station coordinates, the base station may instruct the UE on how to compensate for movement of one or more components of the communication link. UE movement may occur in angular or radial direction as compared to the base station beam. Depending on the UE movement, the UE may be instructed to update its azimuth and/or elevation angles. The angular changes at the base station for the base station beam may be related to those changes at the UE side to adjust the UE beam. In other words, there may be an angular correspondence between the base station beam update and UE beam update.

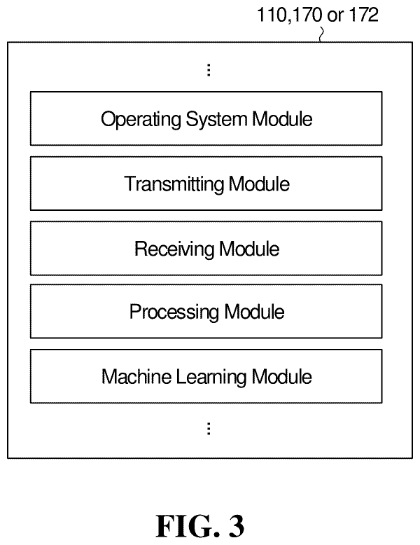

FIG. 4A illustrates an example of part of a network that includes a base station 410, a UE 420 and a reflector 430. The base station 410 may communicate directly with the UE 420 via a UE beam 422 and a base station beam 412 that are aligned, where the devices communicate using a line or sight (LOS) beam pair. The base station 410 may also, or alternatively, communicate with the UE 420 via a path involving the reflector 430 with UE beam 424 and base station beam 414 aligned using a NLOS beam pair.

FIG. 4B illustrates another example of the part of the network that includes the base station 410, the UE 420 and the reflector 430. In FIG. 4B the UE 420 is shown moving in a direction according to the arrow 425. The base station 410 and the UE 420 may both update their respective beams by shifting the beams by θ degrees to the same direction (in this case to the left from the perspective of each device) when there is beam angle correspondence. A similar correspondence also may occur when the base station 410 and UE 420 are operating using the NLOS beam. FIG. 4B shows how a change in angle of γ degrees for the NLOS path from the base station 410 for the movement of the UE 420. Similarly, but not shown, the UE beam along the NLOS path would also change by γ degrees. In general, angle correspondence may be used to update both the base station beam and UE beam. Because the base station 410 may be equipped with more accurate sensors than the UE 420, the base station 410 may be able to provide configuration information to the UE 420 with more accurate updates for the UE beam.

In some embodiments, when the UE is equipped with a two dimensional (2D) antenna array that may beamform according to azimuth and elevation angles (or another angle pair that corresponds to these angles), the base station may configure the UE to track one or both of these angles. For example, a base station may configure the UE to track the azimuth angle for a UE beam, as it may be more important in the beam pair RSRP than the elevation angle. In general, the tracking of each angle may be of different importance and different effect and may be done jointly or separately, and by the same or different update frequency. A UE, such as a cell phone, may be with a pedestrian walking around a park in an unpredictable manner, or a high-speed train moving with high speed on a track that is totally predictable. A different update frequency may be needed according to the speed and predictability of the UE. The UE beam update may happen in a periodic or aperiodic fashion, or when triggered.

In some embodiments, the base station may configure the UE to update one or more UE beam, and for each one or more beam, the base station may update one or two angles, i.e., azimuth and/or elevation. In some embodiments, the update information provided by the base station to the UE may be a value that the UE may use directly to update a specific angle for a beam; e.g., increase azimuth by 3 degrees. In some embodiments, the update information provided by the base station to the UE may be an equation that enables the UE to periodically update UE beam angles; e.g., angleₜ₊₁=angleₜ+a, where the angle update from time slot t to time slot t+1 is by adding a, where a is a parameter provided by the base station. The angle being updated may be an azimuth angle, or an elevation angle, or a combination thereof. The parameter in the equation may depend on one or more variables such as the UE location, the UE velocity and an update interval. Different equations may be used, and such equations may require one or more parameters to be sent from the base station to the UE to enable UE beam tracking. The base station may also instruct the UE to update the UE beam according to the UE location. For example, the UE may maintain a particular UE beam until a certain UE location is reached, and after the UE reaches that location, the UE switches to another UE beam. In another example, the UE may be instructed of a UE beam angle for a certain location that the UE is heading toward, and the UE gradually shifts the UE beam to that angle as it approaches the location. In a third example, the UE may be instructed with an equation that enables the UE to periodically update UE beam angles according to its location.

While UE movements may probably be the largest cause of beam misalignment, base station movement, when the base station is capable of moving, may also affect beam misalignment. Examples of base stations that are capable of moving may include, but are not limited to, a drone, high altitude platform system (HAPS), or a satellite. Such a base station may move in a well-defined path, which is the case for satellites, or may be moved as needed such as for drone base stations. Since in such cases the base station knows its movement profile and may update the base station beam to keep pointing to the UE, the base station may instruct the UE to update the UE beam as well to compensate for potential beam misalignment. One example of a beam misalignment may happen if the UE and base station are communicating using a NLOS path on which a signal is reflected from a moving reflector; e.g., truck and the base station and UE beams are directed toward the reflector. However, a UE beam in this situation may be less reliable and so such a UE beam may be of less importance to track.

In some embodiments, the base station may instruct the UE on how to update the UE beam that is used as part of the serving beam pair. In embodiments in which the UE is capable of beamforming more than one beam, the base station may instruct the UE to update one or more serving beam pairs. In some embodiments, the base station may also instruct the UE on how to update beams that may be used for other functions such as beam reporting, beam switching, beam failure recovery or for beams that may be used from another base station for possible hand over. The base station may use different update frequency, i.e., how often the base station may provide update information or trigger an update, for each beam, with the same or different equations for each beam. In some embodiments, the base station may instruct the UE to track the UE beam to compensate the movement of the UE, or the base station, or both.

In some embodiments, it may be possible to associate the UE beam tracking with other configured parameters. For example, a UE may be configured with a time advance for a certain beam to compensate for trip time of the signal traveling between the base station and UE. When the UE moves in a radial direction, the time advance changes as the overall trip time changes because the UE is moving toward or away from the base station, while for an angular direction, the time advance may be the same as the trip time may be substantially the same. In some embodiments, the azimuth and elevation angle updates may be related to whether the UE moves in a radial or an angular direction.

Some embodiments relate to beamforming methods between the UE and the base station. Accordingly, aspects of the disclose may be applied to situations where the UE may be capable of analog beamforming e.g., smart phone, drone, vehicle, internet of things (IoT), etc.

It should also be understood that while the majority of discussion in this disclosure pertains to communications between the UE and the base station, UE beam tracking may be implemented for other scenarios as well. For example, a base station may configure a first UE to track the transmitted beam from a second UE when the first and second UEs are communicating using sidelink communication. Furthermore, aspects of the disclosure may be used for any of UL, DL, or sidelink and for frequency division duplex (FDD) or time divisional duplex (TDD) systems.

In some embodiments, the base station informs the UE regarding tracking information for a UE beam that is part of a serving beam pair. Such embodiments may be preceded by the base station and UE aligning their respective beams for best performance, and communication between the base station and the UE to configure the UE to be able to understand the base station information in terms of the UE local coordinates.

In some embodiments, the base station may send an update including beam angle information for the UE beam in which the UE uses the beam angle information that includes a new beam angle instead of the old angle, or a relative beam angle to update the old beam angle, where the UE adds or subtracts the relative beam angle from the old beam angle and uses the new resulting angle. In some embodiments, the base station may send equation update information to update the beam angle based on the equation update information that can be used over multiple time instances. The equation update information may contain one or more parameters that are configured by the base station that may be used by the UE to update the UE beam. In some embodiments, the UE may use the equation to update the UE beam at certain intervals. In some embodiments, the UE may use the equation to update the UE beam according to the UE location. An example equation is a linear equation, where the UE adds or subtracts a configured beam angle each time slot, where the configured angle is provided by the base station. The base station may update more than one beam angle for the serving beam; e.g., azimuth and elevation, and there may be more than one serving beam if the UE is capable of multi-beam communication. Accordingly, the base station may configure more than one beam angle or relative beam angle or equation update for the UE. The beam angle or the relative beam angle may be sent by control channels as a media access control-control element (MAC-CE), where the equation update may be sent by radio resource control (RRC) signaling. In some embodiments, the equation update may be turned on or off by a MAC-CE command.

In some embodiments, the base station may configure the beam angle update in an indirect manner as opposed to providing a particular beam angle, relative beam angle or an equation. In one example, when the base station and UE are communicating using a LOS beam, the base station may provide the UE with the base station location, and the UE points the UE beam in the provided direction. In another example, when the base station and UE are communicating using a NLOS beam, the base station may provide the UE with information that is related to a location of the reflector, and the UE may use such information to direct the UE beam to that reflector location. In another example, the base station may inform the UE regarding the base station codebook and the UE may use angular relations between the different transmit beams to point the UE beam.

Because the beam update may rely on the UE location and velocity, which may be acquired with different accuracies, a base station update for the UE may include a range of beam angles that the UE may use for communication. Therefore, the UE may use a wide beam for a provided range, or sweep through such a provided range using one or more narrow beam. The range of the beam angles may relate to the accuracy of the UE movement and sensing information.

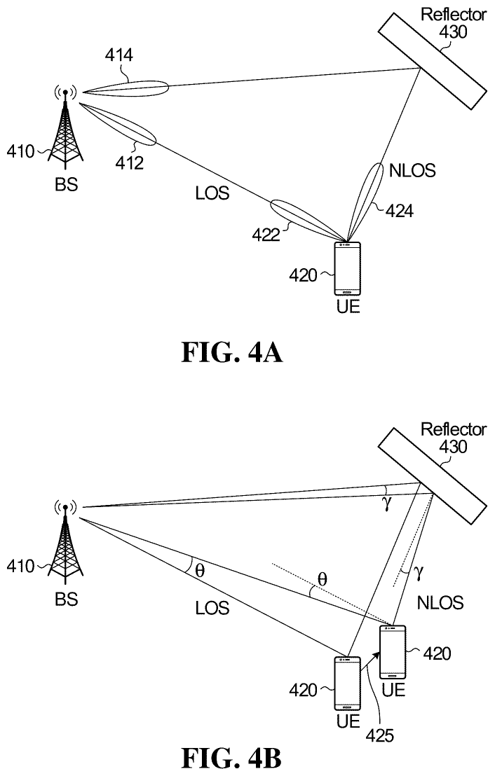

FIG. 5 illustrates an example of a signal flow diagram for communication signaling between a base station 510 and a UE 520. A first signaling 530 includes an initial link establishment and the start of communication. At signaling 540, the UE 520 sends an indication of UE beam tracking capabilities to the base station 510. The UE beam tracking capabilities may include one or more of: an indication of a capability of the UE to compensate for UE orientation changes; an indication as to whether the UE can use an equation provided in beam tracking update configuration information to update beam information; an indication as to whether the UE includes at least one of a gyroscope or compass; an indication of a number of antenna panels at the UE; and an indication as to whether the UE is capable of beamform one or more beams.

At signaling 550, the base station 510 replies with configuration information to update the UE beam tracking that enables the UE 520 to update the UE beam. In one example, the base station 510 may use a relative angle that is configured by using MAC-CE signaling. In another example, the base station 510 sends parameters that are associated with an equation that enables the UE 520 to update the UE beam. The equation parameters may be configured by RRC signaling and then triggered on or off by MAC-CE signaling.

After the UE 520 updates the UE beam, communication may continue on the new beam pair that includes the updated UE beam. In some embodiments, the signaling may be on a physical downlink shared channel (PDSCH) that contains demodulation reference signal (DMRS) as part of the communication. In some embodiments, the UE beam tracking update in signaling 550 may include a range for the beam angle. The UE 520 may then sweep through (not shown) the beam angle range using a narrow beam to find a preferred beam angle. An instruction to perform the beam sweep through the beam angle range may be included in the configuration information. The UE may update the UE beam based on the UE beam tracking capability information and the beam tracking update configuration information periodically; aperiodically; or as a result of a triggering signal.

For a periodic update, the UE may be configured to update the UE beam each time interval. For an aperiodic update, the UE beam angle may be updated the when the UE is moving. For example, a UE that is a vehicle would increment the UE beam angle when the UE is moving, not when stopped, such as at a stop sign. For a triggered update, the base station may send a trigger signal. For example, a base station may trigger an azimuth angle update when angular movement is detected.

When the base station provides the UE with information that enables UE beam tracking for the serving beam pair, the UE updates the UE beam to provide improved beam pair RSRP. This may enable higher transmission rates, a better communication experience, and may lower beam switching and beam failure instances.

In some embodiments, the base station may inform the UE about the UE beam tracking information for the UE beam for other beam pairs with different functionality. Other beam pairs with other functionality may include a UE beam that is part of the beam pair that may be used for beam switching, that may be reported by the UE, that may be used for beam failure recovery, or that may be used for hand over. Beam pair RSRP may be reported or used for various reasons as a part of beam management.

In some embodiments, the base station may configure a UE beam for the UE for a certain beam pair by providing the UE with a beam angle (or more than one beam angle or a beam angle range) that is relative to the UE beam being used as the serving beam that is already established. The UE uses the angle(s) of the UE serving beam and the relative beam angle(s) or beam angle range to obtain an updated angle(s) for that beam pair. In some embodiments, the base station may send the beam angle directly to the UE to use for the required beam pair. In some embodiments, the base station may send an equation to update the beam angle for more than one time or location once an initial beam angle is determined. In some embodiments, the beam angle, the relative beam angle, or the beam angle range may be sent by control channels such as MAC-CE. In some embodiments, the equation update may be sent by RRC and may be turned on or off by a MAC-CE command. The equation may enable the UE to update the beam angle from one time slot to another, where the amount of the beam angle to be added or subtracted from the current angle is configured by the base station. In some embodiments, the equation may be used by the UE to update the beam angle according to the location of the UE. The base station may provide more than one beam angle for a given beam pair; e.g., azimuth and elevation, and there may be more than one beam pair for various beam management procedures.

In some embodiments, the base station may configure the beam angle update in an indirect manner. For example, when the beam pair that is being tracked is a NLOS beam that is reflected from a certain reflector, the base station may provide the UE with information that is related to the location of the reflector, and the UE may use such information to direct the UE beam to that reflector location. In another example, the base station may inform the UE regarding the base station codebook and the UE may use the angular relations between the different transmit beams to update the UE beam.

Because the beam update may rely on the UE location and the UE velocity, which may be acquired with different accuracies, an update by the base station for the UE may include a range of angles that the UE may use to update the UE beam. In some embodiments, the UE may use a wide beam that encompasses the range, or the UE may sweep through this range using one or more narrow beam. The range of the beam angles may relate to the accuracy of UE movement and sensing information.

In some embodiments, the UE beam tracking may depend on a purpose for the beam pair and how the beam pair is used in the beam management process. For example, the beam tracking may depend on whether the beam pair is related to beam reporting, beam switching, beam failure recovery, or for possible hand over. This may also be related to whether the beam is used for control or data communication, and whether the beam is used for unicast, multicast, or broadcast transmission.

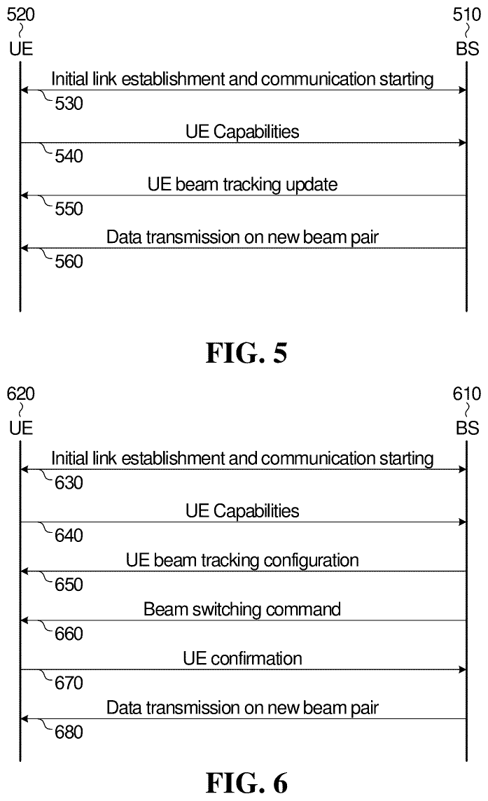

FIG. 6 illustrates an example of a signal flow diagram for communication signaling between a base station 610 and a UE 620. A first signaling 630 includes establishing an initial link and starting communication. At signaling 640, the UE 620 sends an indication of UE beam tracking capabilities to the base station 610. At signaling 650, the base station 610 replies with configuration information to update the UE beam tracking that enables the UE 620 to update the UE beam. In this example, the beam angle update is for a beam that may be used for beam switching. Once the base station 610 initiates beam switching with a beam switching command 660. The UE sends 670 a confirmation message 670 of the beam switching command. The UE 620 updates the UE beam as configured based on the beam switching comments and uses this new beam as the current serving beam as part of the beam switching and data transmission communication 680 resumes on the new beam pair which may be associated with DMRS. In some embodiments, the UE beam tracking update in signaling 650 may include a range for the beam angle. The UE 620 may then sweep through (not shown) the beam angle range using a narrow beam to find a preferred beam angle.

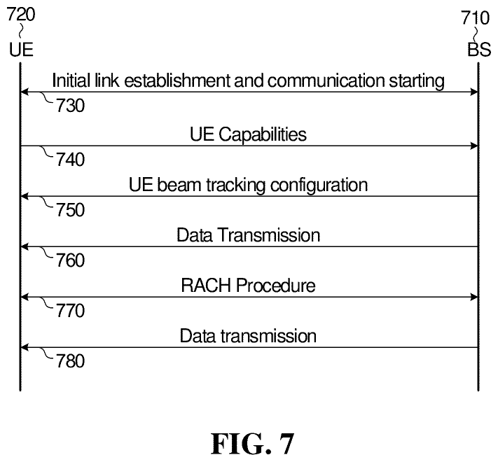

FIG. 7 illustrates an example of a signal flow diagram for communication signaling between a base station 710 and a UE 720. A first signaling 730 includes establishing an initial link and starting communication. At signaling 740, the UE 720 sends an indication of UE beam tracking capabilities to the base station 710. At signaling 750, the base station 710 replies with configuration information to update the UE beam tracking that enables the UE 720 to update the UE beam. In this example, the beam angle update is for a beam that may be used as part of beam failure recovery. At some point during data transmission communication 760 between the base station 710 and UE 720, the UE 720 detects beam failure, the UE 720 initiates a beam failure recovery procedure to search for other possible beams that correspond with a UE beam configured for beam failure recovery. When a beam is found, the UE may initiate a random access channel (RACH) request as part of the RACH procedure 770 to establish a new connection on the new UE beam. The beam recovery is considered successful when the UE receives the RACH response as part of the RACH procedure 770. When the RACH procedure is successful data transmission communication 780 may continue on the new beam pair. In some embodiments, the signaling may be on a PDSCH that contains DMRS as part of the communication.

In some embodiments, a similar signaling method may occur in which the UE 720 tries to connect with beams from other base stations (not shown) using the configured UE beam when the beam failure recovery is not successful for serving base station.

Because the base station provides the UE with information that enables UE beam tracking for beam pairs other than the serving pair, the UE may get better beam pair RSRP for reporting or when using beam pairs other than the serving pair. This may enhance various beam management processes that rely on alternative beam pairs that may be used for beam reporting, beam switching, beam failure recovery and beams from other base stations that may be used for possible hand over.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method, comprising:
transmitting user equipment (UE) beam tracking capability information;
receiving beam tracking update configuration information; and
updating a UE beam based on the UE beam tracking capability information and the beam tracking update configuration information; and
wherein updating of the UE beam is performed:
periodically, or aperiodically, or as a result of a triggering signal.

2. The method of claim 1, wherein the beam tracking update configuration information provides information for tracking one or more of:
a UE beam for a serving beam; or
an alternative UE beam for UE beam management processes.

3. The method of claim 2, wherein the UE beam is one or more of:
a UE beam that is used for the serving beam;
a UE beam that is used for beam switching;
a UE beam that is used for handover; or
a UE beam that is used for beam failure recovery.

4. The method of claim 1, wherein the UE beam tracking capability information comprises one or more of:
an indication of a capability of the UE to compensate for UE orientation changes;
an indication as to whether the UE is able to use an equation provided in the beam tracking update configuration information to update beam information;
an indication as to whether the UE includes at least one of a gyroscope or compass;
an indication of a number of antenna panels at the UE; or
an indication as to whether the UE is capable of beamforming one or more beams.

5. The method of claim 1, wherein the beam tracking update configuration information comprises one or more of:
beam angle information;
equation information enabling at least one of a time dependent update or a location dependent update;
geometry information pertaining to a reflector between the UE and a serving base station; or
reflector location information.

6. An apparatus comprising:
a communication interface; and
one or more processors, wherein when executing program instructions stored in the apparatus, the one or more processors cause the apparatus to:
transmit user equipment (UE) beam tracking capability information;
receive beam tracking update configuration information; and
update a UE beam based on the UE beam tracking capability information and the beam tracking update configuration information; and
wherein the updating the UE beam is performed:
periodically, or aperiodically, or as a result of a triggering signal.

7. The apparatus of claim 6, wherein the beam tracking update configuration information provides information for tracking one or more of:
a UE beam for a serving beam; or
an alternative UE beam for UE beam management processes.

8. The apparatus of claim 7, wherein the UE beam is one or more of:
a UE beam that is used for the serving beam;
a UE beam that is used for beam switching;
a UE beam that is used for handover; or
a UE beam that is used for beam failure recovery.

9. The apparatus of claim 6, wherein the UE beam tracking capability information comprises one or more of:
an indication of a capability of the UE to compensate for UE orientation changes;
an indication as to whether the UE is able to use an equation provided in beam tracking update configuration information to update beam information;
an indication as to whether the UE includes at least one of a gyroscope or a compass;
an indication of a number of antenna panels at the UE; or
an indication as to whether the UE is capable of beamforming one or more beams.

10. The apparatus of claim 6, wherein the beam tracking update configuration information comprises one or more of:
beam angle information;
equation information enabling at least one of a time dependent update or a location dependent update;
geometry information pertaining to a reflector between the UE and a serving base station; or
reflector location information.

11. A method comprising:
receiving user equipment (UE) beam tracking capability information; and
transmitting beam tracking update configuration information; and
wherein the UE beam tracking capability information and the beam tracking update configuration information are used to update a UE receive beam periodically, or aperiodically, or as a result of a triggering signal.

12. The method of claim 11, wherein the beam tracking update configuration information provides information for tracking one or more of:
a UE beam for a serving beam; or
an alternative UE beam for UE beam management processes.

13. The method of claim 12, wherein the alternative UE receive beam or beam pair is one of:
a UE beam that is used for the serving beam;
a UE beam that is used for beam switching;
a UE beam that is used for handover; or
a UE beam that is used for beam failure recovery.

14. The method of claim 11, wherein the UE beam tracking capability information comprises one or more of:
an indication of a capability of the UE to compensate for UE orientation changes;
an indication as to whether the UE is able to use an equation provided in beam tracking update configuration information to update beam information;
an indication as to whether the UE includes at least one of a gyroscope or compass;
an indication of a number of antenna panels at the UE; or
an indication as to whether the UE is capable of beamforming one or more beams.

15. The method of claim 11, wherein the beam tracking update configuration information comprises one or more of:
beam angle information;
equation information enabling at least one of a time dependent update or a location dependent update;
geometry information pertaining to a reflector between the UE and a base station; or
reflector location information.

16. An apparatus comprising:
a communication interface; and
one or more processors, wherein when executing program instructions stored in the apparatus, the one or more processors cause the apparatus to:
receive user equipment (UE) beam tracking capability information; and
transmit beam tracking update configuration information; and
wherein the UE beam tracking capability information and the beam tracking update configuration information are used to update a UE receive beam periodically, or aperiodically, or as a result of a triggering signal.

17. The apparatus of claim 16, wherein the beam tracking update configuration information provides information for tracking one or more of:
a UE beam for a serving beam; or
an alternative UE beam for UE beam management processes.

18. The apparatus of claim 17, wherein the alternative UE receive beam or beam pair is one of:
a UE beam that is used for the serving beam;
a UE beam that is used for beam switching;
a UE beam that is used for handover; or
a UE beam that is used for beam failure recovery.

19. The apparatus of claim 16, wherein the UE beam tracking capability information comprises one or more of:
an indication of a capability of the UE to compensate for UE orientation changes;
an indication as to whether the UE is able to use an equation provided in beam tracking update configuration information to update beam information;
an indication as to whether the UE includes at least one of a gyroscope or compass;
an indication of a number of antenna panels at the UE; or
an indication as to whether the UE is capable of beamforming one or more beams.

20. The apparatus of claim 16, wherein the beam tracking update configuration information comprises one or more of:
beam angle information;
equation information enabling at least one of a time dependent update or a location dependent update;
geometry information pertaining to a reflector between the UE and a base station; or
reflector location information.
